(19) United States
(12) Patent Application Publication
(10) Pub. No.: US 2004/0207851 A1
(43) Pub. Date: Oct. 21, 2004

(54) Device and method for the spectroscopic measurement of concentration gas

(76) Inventor: Andreas Dietrich, Munchen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/476,696

(22) PCT Filed: May 2, 2002
(86) PCT No.: PCT/EP02/04823

(30) Foreign Application Priority Data
May 5, 2001 (DE) 101 21 932.6

(51) Int. Cl. G01N 21/00

(52) U.S. Cl. 356/436

(57) ABSTRACT

A method and device for measuring concentration of at least one component of a process gas by a laser whereby the beam of the laser passes through a volume containing the process gas. The beam extends partially in a free manner through the process gas and partially through in a insulated manner with respect to the process gas. Only one part of the beam which extends freely through the process gas is designated as a measuring section and is taken into account for laser-gas spectroscopic measurement of the concentration of the constituent of the process gas.

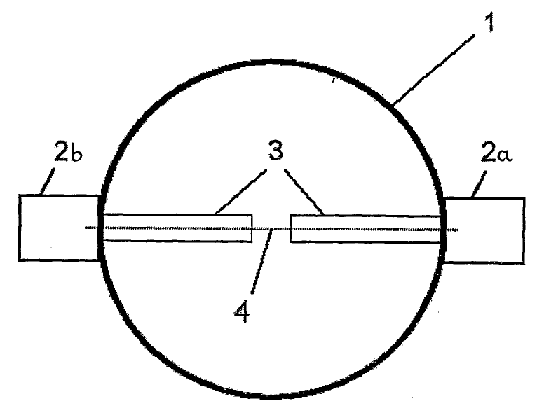

This application claims the priority of German Patent document 101 21 932.6, filed 05 May 2001, (PCT International Application No. PCT/EP02/04823, filed 02 May 2002), the disclosure of which is expressly incorporated by reference herein.

### SUMMARY OF THE INVENTION

The invention relates to a device and to a method for the measurement of a concentration of at least one constituent of a process gas by means of a laser, the beam path of the laser traversing a volume containing the process gas.

Measuring methods and devices are known for determining the concentration of individual constituents of a gas mixture, which are determined by using a laser for laser-gas-spectroscopic measurements.

When using laser-gas-spectroscopic methods for determining the concentration of constituents in dust-laden process gases (gas mixtures), the known methods are, however, limited by the occurring absorption and reflection of the laser radiation by the dust particles. When the dust load is high and the measured distances are fairly large, for example, over a fairly large tube cross-section, the intensity of the laser radiation decreases to such a large extent along the measured distance that no usable signal arrives at the detector. The known methods are therefore not suitable for the described applications.

The above-described application situation occurs relatively frequently in the field of metal working or power harnessing and power plant technology since (process) these gases are contaminated by dust in large quantities. However the composition of these gases is of great interest to the operator of the facility.

It is therefore an object of the present invention to provide an improved method and an improved device for implementing laser-gas-spectroscopic measurements of the concentration of the constituents of a process gas, in which case it is particularly important that the invention is also suitable for large volumes of dust-laden process gases.

With respect to the device, this object is achieved by using a beam path which partially extends freely through the process gas and partially extends in a manner shielded from the process gas, with only the part of the beam path which extends freely through the process gas being called the measured section.

The shield of the beam path is preferably constructed as a hollow body. In particular devices for feeding a cleansing gas are provided in the area of the shield, which cleansing gas is used for displacing the process gas from the shield, particularly from the interior of the hollow body. As a result, a clean gas of a known composition is advantageously situated in the interior of the shield, by which the intensity of the laser beam experiences almost no weakening, and which gas exhibits a neutral behavior for the concentration measurement or, because of the known composition, can subsequently be eliminated again from the measurement. Nitrogen, for example, is very suitable for use as the cleansing gas. Inert gases are generally also considered suitable. The suitability of a gas for use as a cleansing gas depends, among other things, on which constituent of the process gas is to be measured with respect to its concentration.

In an advantageous further development of the invention, the shield has a tube-shaped construction. In particular, the shield is constructed as a water-cooled lance. As a result of this construction, the device according to the invention for measuring the concentration can also be used without any problem in process gases which have a very high temperature.

In a further development of the invention, the shield has a heat-resisting and/or acid-proof material. Preferably, the shield has a ceramic material. These materials also permit the problem-free use of the device according to the invention under difficult conditions, for example, in the presence of acidic constituents in the process gas.

According to a further development of the invention, the shield is mounted at the start of the beam path at the laser as well as in front of a detector onto which the laser radiation impinges, whereby the measured section is bounded by the shield on both sides. This further development has, among others, the advantage that possibly existing marginal effects (effects in the marginal area of a gas volume) are extracted from the measurement. Disturbing marginal effects may occur, for example, in a flowing process gas.

With respect to the method, this object is achieved in that the beam path partially extends freely through the process gas and partially extends in a manner shielded from the process gas with only the part of the beam path which extends freely through the process gas being called the measured section and being used for a laser-gas spectroscopic measuring of gas concentrations. A method designed in this manner permits a reliable measurement over fairly large measured sections and in dust-laden or otherwise contaminated process gases or process gases generally mixed with particles.

The shield is advantageously cleared by means of a cleansing gas. Nitrogen is particularly advantageously used as a cleansing gas. As a result, a clean gas of a known composition is advantageously situated in the interior of the shield, whereby the intensity of the laser beam experiences almost no weakening, and which gas exhibits a neutral behavior for the concentration measurement; that is, it makes no contribution unless the concentration of a nitrogen compound is to be measured. Expressed in general terms, the suitability of a gas for use as a cleansing gas depends on which constituent of the process gas is to be measured with respect to its concentration. As a rule, a cleansing gas is selected which clearly differs with respect to the spectroscopy from the gas whose concentration is to be determined.

Inert gases can advantageously be used as cleansing gases. In the case of inert gases, the special advantage consists of the fact that a chemical reaction between the cleansing gas and the process gas can be excluded.

According to another advantageous further development of the method, ambient air is taken in and is used as cleansing gas. This further development mainly offers the advantage of low process costs. However, the presence of ambient air is not desirable in all applications; for example, when determining the CO— concentration in an exhaust gas, ambient air used as cleansing gas would interfere with the measurement.

Nitrogen is to be preferred as the cleansing gas for measurements of the oxygen concentration in a process gas.

Furthermore, the invention has the advantage that a low-power laser can be used for measuring the concentration, because the measured section is shortened as a result of the shield according to the invention in comparison to a measurement without a shield. In addition, the use of a low-power laser reduces the danger of undesirable changes in the process gas which can be triggered by the energy of the laser radiation in the process gas.

The invention as well as additional details will be described in detail in the following by means of an embodiment illustrated in the drawing.

### BRIEF DESCRIPTION OF THE DRAWINGS

The single FIGURE is a cross-sectional view of a volume containing the process gas.

### DETAILED DESCRIPTION OF THE PREFERRED EMBODIMENT

The FIGURE shows a volume 1 which contains the process gas, is bounded in a tube-shaped manner and has a laser 2a on one side and a detector 2b on the opposite side. The detector 2b registers the laser radiation traversing the volume 1 and impinging upon the detector 2b. The beam path of the laser 2a is partially surrounded by the shield 3 which bounds the measured section 4 on both sides; in the direction toward the laser 2a as well as in the direction toward the detector 2b. Devices for feeding a cleansing gas, such as nitrogen, are advantageously provided on the shield 3. These devices are not illustrated in the FIGURE.

The volume 1 is filled, for example, by a hot process gas whose content of carbon monoxide is to be determined. For this purpose, a shield 3 is used which has two water-cooled ceramic tubes 3. A gaseous nitrogen is used as the cleansing gas and displaces the process gas as from the interior of the ceramic tubes 3, which are cooled, for example, by tube coils (not shown) carrying cooling water.

As a function of the distance between the laser 2a and the detector 2b, a shield 3 according to the invention advantageously has such dimensions that the measured section 4 has a length of, for example, 10 cm to 30 cm. A measured section 4 of approximately 20 cm was found to be particularly advantageous.

The laser measurements can particularly advantageously be implemented as continuous measurements. However, in another embodiment of the invention, discontinuous measuring methods can also be used successfully.

1-11. (Cancelled).

12. A device for measuring concentration of at least one constituent of a process gas, said device comprising:
a container confining a predetermined volume of said process gas;
a laser means positioned at a first surface portion of said container;
detector means positioned on a second portion of said surface of said container wherein said second portion is opposite said first portion and wherein said laser outputs a beam traversing an interior portion of said volume between said first portion of said surface and said second portion of said surface along a beam path;
shield means surrounding at least a first portion of said beam path;
means for substantially removing said process gas from said at least first portion of said beam path surrounding by said shield means in order to measure said at least one constituent of said process gas in a measuring section defined by a second portion of said beam path not surrounded by said shield means.

13. The device according to claim 12, wherein the shield means is at least one hollow body.

14. The device according to claim 12, further including means for feeding a cleansing gas in the area of the shield means wherein said cleansing gas functions to displace the process gas from said surrounding.

15. The device according to claim 12, wherein said shield means is in the shape of a tube.

16. The device according to claim 12, wherein said shield means is a water-cooled lance.

17. The device according to claim 12, wherein said shield means includes at least one of a heat-resisting and an acid-proof material.

18. The device according to claim 12, wherein said shield means includes a ceramic material.

19. The device according to claim 12, wherein said shield means includes a first portion mounted proximal to said laser and a second portion mounted proximal to said detector means.

20. A method for measuring concentration of at least one constituent of a process gas comprising the steps of:
providing a volume of process gas in a container;
providing a laser on one surface of the said container, said laser outputting a beam along a path which traverses said volume;
providing a detector on a second surface of said container opposite said first surface for receiving said output beam;
shielding at least one portion of said beam path to provide that said shielded at least one portion is essentially free of said process gas.

21. The method according to claim 20, wherein said step of shielding includes providing a cleansing gas.

22. The method according to claim 21, wherein said cleansing gas is nitrogen.

23. Apparatus for measuring concentration of at least one constituent of a process gas, comprising:
a laser device outputting a beam traversing a volume of process gas along a beam path;
at least one shielding device surrounding said beam path for at least one portion of a length of said traversal through said volume of said process gas wherein said shielding means includes a cleansing means for removing a substantial portion of said process gas from a vicinity of said at least one portion of said length.

24. The device according to claim 20, wherein the shield means is at least one hollow body.

25. The device according to claim 23, further including means for feeding a cleansing gas in the area of the shield wherein said cleansing gas functions to displace the process gas from said surrounding.

26. The device according to claim 23, wherein said shield means is a water-cooled lance.

27. The device according to claim 23, wherein said shield means includes at least one of a heat-resisting and an acid-proof material.

28. The device according to claim 23, wherein said shield means includes a ceramic material.

29. The device according to claim 23, wherein said shield means includes a first portion mounted proximal to said laser device and a second means mounted proximal to a detector means.
